(19) United States
(12) Patent Application Publication
(10) Pub. No.: US 2026/0050902 A1
(43) Pub. Date: Feb. 19, 2026

(54) SYSTEMS AND METHODS FOR VALIDATING INTENDED RECIPIENTS FOR ELECTRONIC FUNDS TRANSFER

(71) Applicant: Capital One Services, LLC, McLean, VA (US)

(72) Inventors: Joshua Edwards, Philadelphia, PA (US); Michael Mossoba, Arlington, VA (US); Tyler Maiman, Melville, NY (US)

(21) Appl. No.: 18/806,527

(22) Filed: Aug. 15, 2024

(51) Int. Cl. G06Q 20/20; G06Q 20/10

(52) U.S. Cl. CPC G06Q 20/204; G06Q 20/10

(57) ABSTRACT

Disclosed embodiments may include a method for validating intended recipients for electronic funds transfer by receiving recipient identification information from a user device, identifying a list of one or more candidate recipients based on the recipient identification information, and outputting the list of the one or more candidate recipients for display via a graphical user interface (GUI) of the user device. Next, for each candidate recipient of the one or more candidate recipients, the method can identify one or more themes associated with past transactions associated with the candidate recipient, and, responsive to dynamically receiving transfer memo information from the user device, dynamically adjust an order of the list of the one or more candidate recipients for display via the GUI of the user device based on comparing the one or more themes and the transfer memo information.

The disclosed technology relates to systems and methods for validating intended recipients for electronic funds transfer. Specifically, this disclosed technology relates to validating intended recipients of electronic funds transfers by using natural language processors with graphical user interfaces (GUIs).

### BACKGROUND

When a sender transfers funds to a recipient for the first time, the sender may have a lack of confidence that the selected recipient is correct. The selected recipient can at times differ from an intended recipient and the sender must review the available information of the selected recipient to confirm if the selected recipient is correct. Available information accessible by the sender may be insufficient to properly confirm the intended recipient.

Accordingly, there is a need for improved systems and methods for validating intended recipients for electronic funds transfer. Embodiments of the present disclosure are directed to this and other considerations.

### SUMMARY

Disclosed embodiments may include a system for validating intended recipients for electronic funds transfer. The system may include one or more processors, and memory in communication with the one or more processors and storing instructions that, when executed by the one or more processors, are configured to cause the system to validate intended recipients for electronic funds transfer by receiving recipient identification information from a user device, identifying a list of one or more candidate recipients based on the recipient identification information, and outputting the list of the one or more candidate recipients for display via a graphical user interface (GUI) of the user device. Next, for each candidate recipient of the one or more candidate recipients, the instructions can cause the system to identify one or more themes associated with past transactions associated with the candidate recipient, and, responsive to dynamically receiving transfer memo information from the user device, dynamically adjust an order of the list of the one or more candidate recipients for display via the GUI of the user device based on comparing the one or more themes and the transfer memo information.

Disclosed embodiments may include a system for validating intended recipients for electronic funds transfer. The system may include one or more processors, and memory in communication with the one or more processors and storing instructions that, when executed by the one or more processors, are configured to cause the system to validate intended recipients for electronic funds transfer by receiving intended recipient information and transfer memo information, identifying, based on the intended recipient information, a recipient, and identifying, by applying natural language processing (NLP) to the transfer memo information, one or more transfer memo themes. Next, the system can receive a transfer request, wherein the transfer request indicates a request to initiate a transfer to the recipient, obtain historical memo information associated with one or more past transfers to the recipient, and identify, by applying NLP to the historical memo information, one or more recipient themes. Then, responsive to determining that the one or more transfer memo themes do not exceed a predetermined similarity threshold when compared to the one or more recipient themes, the instructions can cause the system to initiate a security action.

Disclosed embodiments may include a system for validating intended recipients for electronic funds transfer. The system may include one or more processors, and memory in communication with the one or more processors and storing instructions that, when executed by the one or more processors, are configured to cause the system to validate intended recipients for electronic funds transfer by receiving intended recipient information and transfer memo information, identifying, based on the intended recipient information, a recipient, and identifying, by applying NLP to the transfer memo information, one or more transfer memo themes. Next, the instructions can cause the system to receive a transfer request, wherein the transfer request indicates a request to initiate a transfer to the recipient, obtain historical memo information associated with one or more past transfers to the recipient, and identify, by applying NLP to the historical memo information, one or more recipient themes. Then, the instructions can cause the system to determine, based on a comparison of the one or more transfer memo themes to the one or more recipient themes, a degree of similarity, and, responsive to determining that the degree of similarity does not exceed a first predetermined similarity threshold, automatically deny the transfer request.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for validating intended recipients for electronic funds transfer in accordance with certain embodiments of the disclosed technology.

FIG. 2 is a flow diagram illustrating an exemplary method for validating intended recipients for electronic funds transfer in accordance with certain embodiments of the disclosed technology.

FIG. 3 is a block diagram of an example memo validation system used to provide validating intended recipients for electronic funds transfer, according to an example implementation of the disclosed technology.

FIG. 4 is a block diagram of an example system that may be used to provide validating intended recipients for electronic funds transfer, according to an example implementation of the disclosed technology.

### DETAILED DESCRIPTION

Examples of the present disclosure related to systems and methods for validating intended recipients for electronic funds transfer. More particularly, the disclosed technology relates to validating intended recipients using natural language processing and graphical user interfaces. The systems and methods described herein utilize, in some instances, GUIs, which are necessarily rooted in computers and technology. Graphical user interfaces are a computer technology that allows for user interaction with computers through touch, pointing devices, or other means. The present disclosure details identifying themes associated with past transactions associated with a list of candidate recipients based on recipient identification information. This, in some examples, may involve using recipient identification information to dynamically change the GUI so that a list of candidate recipients is presented and continuously rearranged in an order with the most likely intended recipient at the top, which involves using a natural language processor with a GUI. Using the GUI in this way may allow the system to prevent a sender from transferring funds to an incorrect recipient. This is a clear advantage and improvement over prior technologies that do not efficiently display or select candidate recipients. The present disclosure solves this problem by continuously rearranging intended recipients for selection based on comparisons of themes of information of recipients derived using natural language processing. Furthermore, examples of the present disclosure may also improve the speed with which computers can generate and dynamically display and rearrange candidate recipients via the GUI. Overall, the systems and methods disclosed have significant practical applications in the financial field because of the noteworthy improvements using the natural language processor with the GUI, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

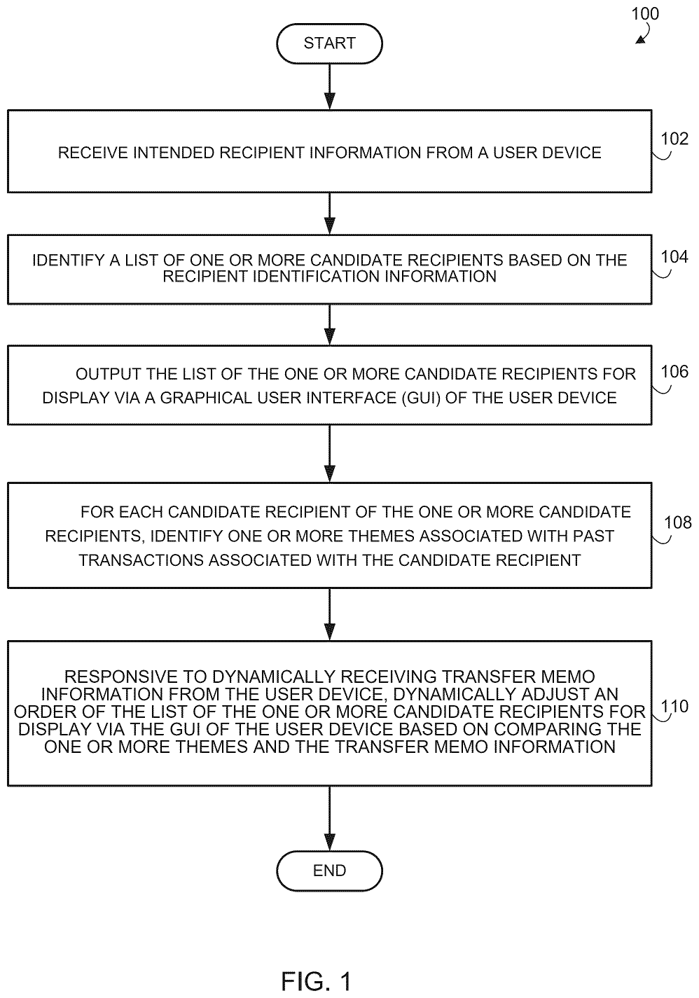

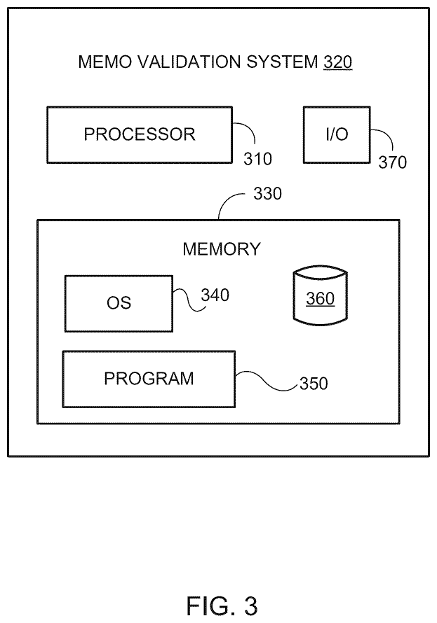

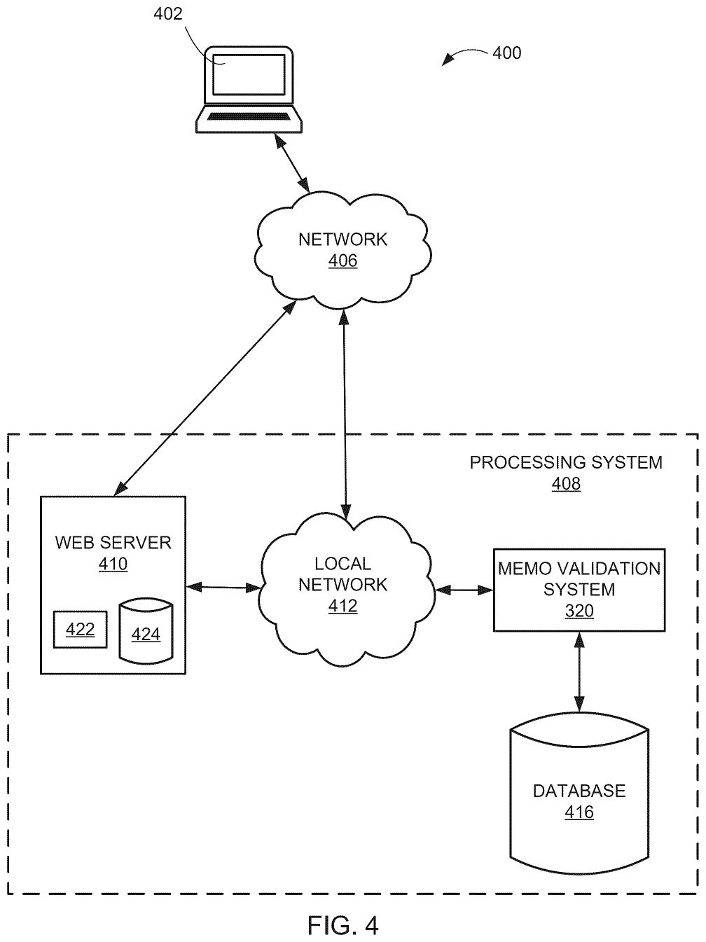

FIG. 1 is a flow diagram illustrating an exemplary method 100 for validating intended recipients for electronic funds transfer, in accordance with certain embodiments of the disclosed technology. The steps of method 100 may be performed by one or more components of the system 400 (e.g., memo validation system 320 or web server 410 of processing system 408 or user device 402), as described in more detail with respect to FIGS. 3 and 4. It should be understood that certain embodiments of the disclosed technology may omit one or more blocks as being optional.

In block 102, the memo validation system 320 may receive intended recipient information from a user device 402. The intended recipient information can be related to an intended recipient (e.g., an individual or an account) and can include an address, an email address, a name, a phone number, a username, account information, or combinations thereof associated with the intended recipient. The memo validation system 320 may receive the intended recipient information via a GUI.

A sender may intend to send funds to the intended recipient. In a non-limiting example, the intended recipient can be the same as a sender at the user device 402. In this non-limiting example, the sender may intend to send funds between one or more accounts (e.g., from a first account to a second account). The memo validation system 320 may receive the intended recipient information (e.g., the sender information) from the user device 402.

In a non-limiting example, the memo validation system 320 may generate the GUI to include a prompt for the intended recipient information. The GUI may also include a prompt for an amount of the funds intended to be transferred to the intended recipient. The memo validation system 320 may then transmit the GUI to the user device 402 to later receive the intended recipient information from the user device 402.

In block 104, the memo validation system 320 may identify a list of one or more candidate recipients based on the recipient identification information. In some embodiments, the one or more candidate recipients may comprise the one or more accounts. In some embodiments, identifying the list of the one or more candidate recipients can include retrieving one or more user profiles from the memo validation system database 360. Each of the one or more user profiles can have associated identification information including a profile address, a profile email address, a profile name, a profile phone number, a profile username, a profile account name, a profile account number, or combinations thereof.

The memo validation system 320 can then identify one or more user profiles having associated identification information within a predetermined threshold level of similarity to the recipient identification information. The memo validation system 320 can identify the one or more user profiles by comparing the recipient identification information against the corresponding associated identification of each user profile (e.g., compare the profile address, the profile email address, and the profile phone number of each user profile against the respective address, the email address, and the phone number of the intended recipient information, etc.). In a non-limiting example, the sender may have a sender user profile including a sender profile address, a sender profile email address, a sender profile name, a sender profile phone number, a sender profile username, a sender profile account name, a sender profile account number, or combinations thereof. In this non-limiting example, the memo validation system 320 may identify the sender user profile as the one or more user profiles when the sender is the intended recipient.

If there is an exact match of any of the associated identification information to the intended recipient information, the memo validation system 320 can include the user profile associated with the identification information with the one or more candidate recipients (e.g., one or more accounts). The memo validation system 320 may also use a machine learning model to detect fuzzy matches between the associated identification information of each user profile against the intended recipient information. The machine learning model may include a large language model that is configured to compare the associated identification information of each user profile against the intended recipient information to detect the fuzzy matches. The machine learning model may also be configured to assign a similarity score (e.g., a degree of similarity) to each fuzzy match detected. The memo validation system 320 can then compare each similarity score to the predetermined threshold level of similarity. In response to determining that one of the similarity scores associated with a fuzzy match is within the predetermined threshold level of similarity, then the memo validation system 320 can include the user profile corresponding to the associated identification information from the fuzzy match as one of the one or more candidate recipients. In a non-limiting example, when the sender is the intended recipient, the memo validation system 320 may include the one or more accounts associated with the sender as the one or more candidate recipients (e.g., the sender linked with each of the one or more accounts can be included in an output as the one or more candidate recipients).

In block 106, the memo validation system 320 may output the list of the one or more candidate recipients (e.g., or the one or more accounts) for display via the GUI of the user device 402. The memo validation system 320 can modify the GUI to include the list of the one or more candidate recipients. Then, the memo validation system 320 can transmit the modified GUI to the user device 402. In some embodiments, the GUI can further include a status or ranking indicator based on the assigned similarity score. The memo validation system 320 may modify the GUI to include a green status indictor next to the corresponding candidate recipients with a highest similarity score or within a predetermined ranking similarity score threshold. The memo validation system 320 may also modify the GUI to include a yellow status indicator next to the corresponding candidate recipients between a second predetermined ranking similarity score threshold and a third predetermined ranking similarity score threshold. The memo validation system 320 may also modify the GUI to include a red status indicator next to the corresponding candidate recipients outside of the first predetermined ranking similarity score threshold, the second predetermined ranking similarity score threshold, and the third predetermined ranking similarity score threshold. In other embodiments, the memo validation system 320 can assign the green status indicator, the yellow status indicator, and the red status indicator based on a position of the candidate recipient on the list after the memo validation system 320 orders the list of the one or more candidate recipients based on their respective similarity scores by using a position status indicator assignment (e.g., the candidate recipient or the corresponding account with a highest similarity score has the green status indicator, the candidate recipients or the corresponding account in a second, third, or fourth position on the list of the one or more candidate recipients have the yellow status indicator, the candidate recipients in a fifth position on the list or lower have the red status indicator). In some embodiments, as the memo validation system 320 dynamically re-calculates the similarity score throughout blocks 104-110 in method 100 (or in similar blocks in method 200), the status indicator for each of the one or more candidate recipients can dynamically or continuously update between the green status indicator, yellow status indicator, or red status indicator based on the first, second, or third determined ranking similarity score thresholds or position status indicator assignments (as outlined in this paragraph).

In block 108, the memo validation system 320 may, for each candidate recipient of the one or more candidate recipients, identify one or more themes associated with past transactions associated with the candidate recipient (e.g., the account). In some embodiments, identifying one or more themes associated with past transactions associated with the candidate recipient can include retrieving past transactions from the memo validation system database 360 and conducting a query to identify a plurality of past transactions where the candidate recipient was a recipient. In other embodiments, the plurality of past transactions can already be associated with the candidate recipient, and the memo validation system 320 can retrieve the plurality of past transactions from the memo validation system database 360 based on the associations to the candidate recipient. The memo validation system 320 can then obtain past memo information from the plurality of past transactions. The past memo information can include information entered into a memo line associated with each transaction of the plurality of past transactions.

The memo validation system 320 can then identify the one or more themes associated with past transactions associated with the candidate recipient (e.g., the account) by applying natural language processing to the past memo information. In this non-limiting example, the natural language processor may be a second machine learning model that uses words or phrases from the past memo information as an input to vectorize the words or phrases by assigning a vector value to each word or each phrase or creating one or more word embeddings. The second machine learning model can be configured to represent the one or more word embeddings and vector values as vectors. The second machine learning model can be configured further to plot the vectors to identify clusters of the vectors by comparing the vectors to other plotted vectors. The second machine learning model may then be configured to use a clustering algorithm known in the art to identify themes associated with each cluster or one or more meanings of each cluster by: (i) calculating cluster centroids representing average vectors in each cluster to determine representative words or phrases in each cluster, (ii) calculating cluster sizes to determine an importance of each cluster, and/or (iii) calculating distances between the clusters to determine similarities, patterns, or relationships between the clusters. The second machine learning model can then be configured to identify the one or more themes based on the representative words or phrases, cluster sizes, cluster patterns, or combinations thereof. The second machine learning model can be configured to output the one or more themes to the memo validation system 320, and the memo validation system 320 can associate each of the one or more themes with the transaction related to the past memo information.

In some embodiments, the memo validation system 320 may modify the GUI to include the one or more themes associated with each of the one or more candidate recipients. In some embodiments, the memo validation system 320 may receive a privacy filter input associated with one of the one or more candidate recipients. The privacy filter input can represent a private theme designated by the corresponding candidate recipient. The memo validation system 320 can then remove the private theme from the one or more themes.

In block 110, the memo validation system 320 may dynamically receive transfer memo information from the user device 402. Transfer memo information can include data related to funds that intend to be transferred to the intended recipient (e.g., “payment for plumbing work,” “childcare payment,” or other information indicating why the funds are being transferred to the intended recipient). The memo validation system 320 may receive the transfer memo information by modifying the GUI to include a request for the transfer memo information and then by transmitting the modified GUI to the user device 402. In response to dynamically receiving transfer memo information from the user device 402, the memo validation system 320 may dynamically adjust an order of the list of the one or more candidate recipients for display via the GUI of the user device 402 based on comparing the one or more themes and the transfer memo information. The memo validation system 320 may compare the one or more themes to the transfer memo information by first generating one or more transfer memo themes. The memo validation system 320 may derive the one or more transfer memo themes from the transfer memo information by using the natural language processor (e.g., the second machine learning model).

The second machine learning model can be configured to use words or phrases from the transfer memo information as an input to vectorize the words or phrases by assigning a vector value to each word or each phrase or creating one or more word embeddings. The second machine learning model can be configured to represent the one or more word embeddings and vector values as vectors. The second machine learning model can be configured further to plot the vectors to identify clusters of the vectors by comparing the vectors to other plotted vectors. The second machine learning model may then be configured to use a clustering algorithm known in the art to identify themes associated with each cluster or one or more meanings of each cluster by: (i) calculating cluster centroids representing average vectors in each cluster to determine representative words or phrases in each cluster, (ii) calculating cluster sizes to determine an importance of each cluster, and/or (iii) calculating distances between the clusters to determine similarities, patterns, or relationships between the clusters. The second machine learning model can then be configured to identify the one or more transfer memo themes based on the representative words or phrases, cluster sizes, cluster patterns, or combinations thereof. The second machine learning model can be configured to output the one or more transfer memo themes to the memo validation system 320, and the memo validation system 320 can associate each of the one or more transfer memo themes with the transaction related to the transfer memo information.

In some embodiments, the memo validation system 320 may receive a privacy filter input associated with one of the one or more candidate recipients. The privacy filter input can represent a private theme designated by the corresponding candidate recipient. The memo validation system 320 can then remove the private theme from the one or more themes prior to comparing the one or more themes to the one or more transfer memo themes.

After the one or more transfer memo themes are derived from the transfer memo information, the memo validation system 320 can continue to dynamically order the list of the one or more candidate recipients for display via the GUI by determining a degree of similarity between one or more transfer memo themes derived from the transfer memo information and the one or more themes associated with past transactions for each candidate recipient of the one or more candidate recipients. The memo validation system 320 may then rank each candidate recipient of the one or more candidate recipients based on the degree of similarity between the one or more transfer memo themes and the one or more themes associated with past transactions associated with the candidate recipient. In some embodiments, each ranking of each candidate recipient of the one or more candidate recipients can be further weighed based on a second degree of similarity (e.g., the degree of similarity outlined in block 104) between the recipient identification information and identification information associated with a user profile associated with the candidate recipient. The memo validation system 320 can then dynamically order the list of the one or more candidate recipients based on the ranking of each candidate recipient.

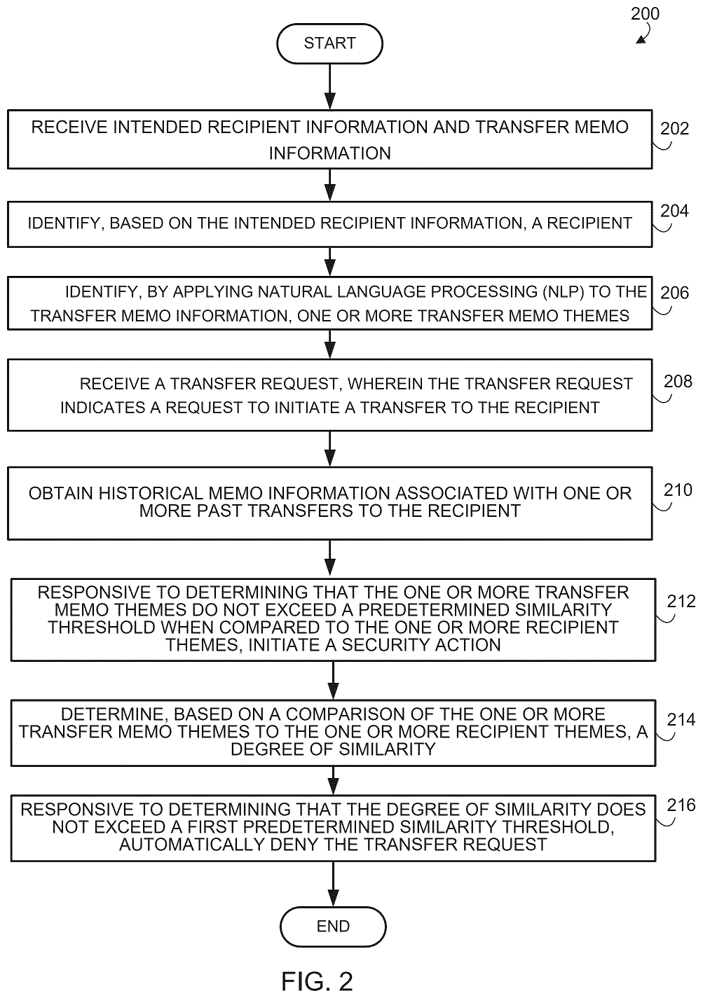

FIG. 2 is a flow diagram illustrating an exemplary method 200 for validating intended recipients for electronic funds transfer, in accordance with certain embodiments of the disclosed technology. The steps of method 200 may be performed by one or more components of the system 400 (e.g., memo validation system 320 or web server 410 of processing system 408 or user device 402), as described in more detail with respect to FIGS. 3 and 4.

Method 200 of FIG. 2 is similar to method 100 of FIG. 1, except that method 200 may not include block 106 of method 100. The descriptions of blocks 202, 204, 206, 210, and 214 in method 200 are similar to the respective descriptions of blocks 102, 104, 110, 108, and 110 of method 100 and are not repeated herein for brevity. However, blocks 202 and 210 are different from respective blocks 102 and 108 and are described below. Additional blocks 208, 212, and 216 are also described below. It should be understood that certain embodiments of the disclosed technology may omit one or more blocks as being optional.

In block 202, the memo validation system 320 may receive the transfer memo information with the intended recipient information from the user device 420. The memo validation system 320 can generate the GUI as outlined in block 110 to include a prompt for the intended recipient information and the transfer memo information. The memo validation system 320 may then transmit the GUI to the user device 402 to later receive the intended recipient information and the transfer memo information from the user device 402. As outlined in block 110 of method 100, the transfer memo information can still include data related to funds that intend to be transferred to the intended recipient.

In block 208, the memo validation system 320 may receive a transfer request. The transfer request can indicate a request to initiate a transfer of funds to the recipient (e.g., the intended recipient). The memo validation system 320 may modify the GUI to include a prompt for the transfer request. The GUI may also include a second prompt for an amount for the transfer request. The transfer request can include a name for the recipient, sender name, recipient phone number, recipient address, recipient bank name, recipient bank information, recipient account information, other transfer request requirements known in the art, or combinations thereof. The memo validation system 320 may then transmit the GUI to the user device 402 to receive the transfer request from the user device 402.

Block 210 in method 200 differs from block 108 from method 100 because the past memo information from block 108 is referred to as historical memo information in block 210. Additionally, the past transactions outlined in block 108 of method 100 can include any activity related to a transfer, whereas the past transfer outlined in block 210 relates to transfer of funds between accounts. In block 210, the memo validation system 320 may also obtain historical memo information associated with one or more past transactions related to the recipient.

In block 212, the memo validation system 320 may compare the one or more transfer memo themes to the one or more themes to determine the degree of similarity as outlined in block 110 of method 100. The memo validation system 320 may compare the degree of similarity against a predetermined similarity threshold. The memo validation system 320 may analyze historical data of fraudulent transfers to determine historical degree of similarities between historical themes and historical intended recipient information and historical transfer memo information related to the fraudulent transactions. The memo validation system 320 may then determine the predetermined similarity threshold based on the historical degree of similarities that resulted in fraudulent transfers.

If the memo validation system 320 determines that the degree of similarity does not exceed the predetermine similarity threshold in this transaction, then the memo validation system 320 may initiate a security action. The security action can include automatically denying the transfer request, causing the GUI of the user device 420 to prompt the user to re-enter the intended recipient information, initiating a transfer of only a portion of a total transfer amount, or combinations thereof. When initiating the transfer of only a portion of the total transfer amount, the memo validation system 320 may initiate a transfer of a first amount and wait a predetermined amount of time before initiating a transfer of a second amount to the recipient. The first amount and the second amount can be portions of a total amount associated or included with the transfer request. In some embodiments, the memo validation system 320 may transmit an authorization request to the user device 420 associated with the transfer request and withhold the initiation of the transfer to the recipient until an affirmative response to the authorization request is received from the user device 420.

In some embodiments, the memo validation system 320 may have levels of confidence by setting one or more predetermined similarity thresholds (as outlined above). If the memo validation system 320 determines that the degree of similarity exceeds the predetermined similarity threshold and does not exceed a second predetermined similarity threshold, then the memo validation system 320 may initiate one of the security action (outlined above). The memo validation system 320 may be configured to select a certain security action based on the level of confidence or based on which predetermined similarity threshold is exceeded.

In some embodiments, if the memo validation system 320 determines that the degree of similarity exceeds the first predetermined similarity threshold and the second predetermined similarity threshold, the memo validation system 320 may initiate the transfer to the recipient using the transfer request. The transfer request can include a name for the recipient, sender name, recipient phone number, recipient address, recipient bank name, recipient bank information, recipient account information, other transfer request requirements known in the art, or combinations thereof. The memo validation system 320 can initiate the transfer to the recipient by transmitting the transfer request to a financial server 410. The memo validation system 320 may receive a confirmation of completion of the transfer from the financial server 410. The memo validation system 320 may modify the GUI to comprise the confirmation of completion of the transfer from the financial server 410. The memo validation system 320 may transmit the modified GUI to the user device 402. The memo validation system 320 may also transmit an alert to a second user device 402 to notify the user of the confirmation of completion of the transfer. In some embodiments, if the memo validation system 320 receives a failure message from the financial server 410, the memo validation system 320 may modify the GUI to comprise the failure message. The memo validation system 320 may then transmit the modified GUI to the user device 402.

If the memo validation system 320 determines that the degree of similarity does not exceed the predetermine similarity threshold in this transaction, then the memo validation system 320 may move to block 104 of method 100 to identify another list of one or more candidate recipients and move through blocks 104 to block 110 of method 100. In addition to dynamically adjusting the order of the list of the one or more candidate recipients, for each candidate recipient, the memo validation system 320 may calculate a respective associated degree of similarity for each candidate recipient. The memo validation system 320 may modify the GUI to include the respective associated degree of similarity for each candidate recipient.

Block 216 of method 200 is similar to block 212 of method 200, except instead of initiating the security actions, the memo validation system 320 may automatically deny the transfer request.

FIG. 3 is a block diagram of an example memo validation system 320 used to validate intended recipients of electronic funds transfers by using natural language processors with GUIs according to an example implementation of the disclosed technology. According to some embodiments, the user device 402 and web server 410, as depicted in FIG. 4 and described below, may have a similar structure and components that are similar to those described with respect to memo validation system 320 shown in FIG. 3. As shown, the memo validation system 320 may include a processor 310, an input/output (I/O) device 370, a memory 330 containing an operating system (OS) 340 and a program 350. In certain example implementations, the memo validation system 320 may be a single server or may be configured as a distributed computer system including multiple servers or computers that interoperate to perform one or more of the processes and functionalities associated with the disclosed embodiments. In some embodiments memo validation system 320 may be one or more servers from a serverless or scaling server system. In some embodiments, the memo validation system 320 may further include a peripheral interface, a transceiver, a mobile network interface in communication with the processor 310, a bus configured to facilitate communication between the various components of the memo validation system 320, and a power source configured to power one or more components of the memo validation system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the memo validation system 320 may include one or more storage devices configured to store information used by the processor 310 (or other components) to perform certain functions related to the disclosed embodiments. In one example, the memo validation system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The memo validation system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the memo validation system 320 may include the memory 330 that may include one or more programs 350 to perform one or more functions of the disclosed embodiments. For example, in some embodiments, the memo validation system 320 may additionally manage dialogue and/or other interactions with the customer via a program 350.

The processor 310 may execute one or more programs 350 located remotely from the memo validation system 320. For example, the memo validation system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a memo validation system database 360 for storing related data to enable the memo validation system 320 to perform one or more of the processes and functionalities associated with the disclosed embodiments.

The memo validation system database 360 may include stored data relating to status data (e.g., average session duration data, location data, idle time between sessions, and/or average idle time between sessions) and historical status data. According to some embodiments, the functions provided by the memo validation system database 360 may also be provided by a database that is external to the memo validation system 320, such as the database 416 as shown in FIG. 4.

The memo validation system 320 may also be communicatively connected to one or more memory devices (e.g., databases) locally or through a network. The remote memory devices may be configured to store information and may be accessed and/or managed by the memo validation system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The memo validation system 320 may also include one or more I/O devices 370 that may comprise one or more interfaces for receiving signals or input from devices and providing signals or output to one or more devices that allow data to be received and/or transmitted by the memo validation system 320. For example, the memo validation system 320 may include interface components, which may provide interfaces to one or more input devices, such as one or more keyboards, mouse devices, touch screens, track pads, trackballs, scroll wheels, digital cameras, microphones, sensors, and the like, that enable the memo validation system 320 to receive data from a user (such as, for example, via the user device 402).

In examples of the disclosed technology, the memo validation system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The memo validation system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The memo validation system 320 may be configured to adjust model parameters during training. Model parameters may include weights, coefficients, offsets, or the like. Training may be supervised or unsupervised.

The memo validation system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The memo validation system 320 may be configured to optimize statistical models using known optimization techniques.

Furthermore, the memo validation system 320 may include programs configured to retrieve, store, and/or analyze properties of data models and datasets. For example, memo validation system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The memo validation system 320 may include algorithms to determine a data type, key-value pairs, row-column data structure, statistical distributions of information such as keys or values, or other property of a data schema may be configured to return a statistical profile of a dataset (e.g., using a data-profiling model). The memo validation system 320 may be configured to implement univariate and multivariate statistical methods. The memo validation system 320 may include a regression model, a Bayesian model, a statistical model, a linear discriminant analysis model, or other classification model configured to determine one or more descriptive metrics of a dataset. For example, memo validation system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The memo validation system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, memo validation system 320 may be configured to generate a similarity metric representing a measure of similarity between data in a dataset. A similarity metric may be based on a correlation, covariance matrix, a variance, a frequency of overlapping values, or other measure of statistical similarity.

The memo validation system 320 may be configured to generate a similarity metric based on data model output, including data model output representing a property of the data model. For example, memo validation system 320 may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The memo validation system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The memo validation system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, memo validation system 320 is configured to generate and/or train a classification model to classify a dataset, consistent with disclosed embodiments.

The memo validation system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the memo validation system may analyze information applying machine-learning methods.

While the memo validation system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the memo validation system 320 may include a greater or lesser number of components than those illustrated.

FIG. 4 is a block diagram of an example system that may be used to view and interact with processing system 408, according to an example implementation of the disclosed technology. The components and arrangements shown in FIG. 4 are not intended to limit the disclosed embodiments as the components used to implement the disclosed processes and features may vary. As shown, processing system 408 may interact with a user device 402 via a network 406. In certain example implementations, the processing system 408 may include a local network 412, a memo validation system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the processing system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the processing system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as RFID, NFC, Bluetooth™, BLE, WiFi™, ZigBee™, ABC protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The processing system 408 may be associated with and optionally controlled by one or more entities such as a business, corporation, individual, partnership, or any other entity that provides one or more of goods, services, and consultations to individuals such as customers. In some embodiments, the processing system 408 may be controlled by a third party on behalf of another business, corporation, individual, partnership, etc. The processing system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the memo validation system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the processing system 408 to interact with one another and to connect to the network 406 for interacting with components in the system 400 environment. In some embodiments, the local network 412 may include an interface for communicating with or linking to the network 406. In other embodiments, certain components of the processing system 408 may communicate via the network 406, without a separate local network 406.

The processing system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access processing system 408 using the cloud computing environment. User device 402 may be able to access processing system 408 using specialized software. The cloud computing environment may eliminate the need to install specialized software on user device 402.

In accordance with certain example implementations of the disclosed technology, the processing system 408 may include one or more computer systems configured to compile data from a plurality of sources the memo validation system 320, web server 410, and/or the database 416. The memo validation system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, a customer John needs to send funds to a recipient Jane for painting services by using his cell phone, a user device 402. In this example, John has never sent funds to Jane before. Company, a banking company, can offer online services that John can utilize to complete the funds transfer request. To gain access to the account, John may send, via the user device 402, a login request with authentication information for his account to the memo validation system 320. The memo validation system 320 may then determine whether the authentication information matches data associated with an account belonging to John. The memo validation system 320, in response to determining that the authentication information matches at least a portion of the data associated with John's account, may authorize the user device 402 to access the account of the user. The memo validation system 320 may then receive from John's cell phone, the user device 402, intended recipient information in the form of a username belonging to Jane to complete the transfer of funds from John's account to Jane's account. As John is entering the intended recipient information, the memo validation system 320 may then dynamically identify a list of one or more candidate recipients based on Jane's username. The memo validation system 320 may then generate a GUI comprising the list of the one or more candidates and transmit the GUI to the user device 402. The memo validation system 320 may retrieve a plurality of past transactions from the memo validation system database 360 based on associations between the plurality of past transactions and each of the candidate recipients. The memo validation system 320 can then obtain past memo information from the plurality of past transactions. The memo validation system 320 can then identify one or more themes associated with the plurality of past transactions associated with each of the candidate recipients by applying natural language processing to the past memo information. A theme associated with the plurality of past transactions of one of the candidate recipients can relate to painting services. The memo validation system 320 can dynamically receive transfer memo information from the user device 420. In this example, John may enter a date the painting services were completed, an address of the work site, and a type of service that was provided (e.g., painting). As John enters each character, word, or phrase as the transfer memo information, the memo validation system 320 can dynamically adjust the order of the list of the one or more candidate recipients based on a comparison of the one or more themes and the transfer memo information. The memo validation system 320 may rank the candidate with the theme relating to painting services higher on the list of the one or more candidates because the services John intends to pay for matches past transactions of the candidate recipient. The memo validation system 320 may also use the natural language processor to determine one or more transfer memo themes derived from the transfer memo information as it is dynamically received. John may then send, via the user device 420, a transfer request to initiate the transfer of funds to Jane's account. The transfer request can include a total transfer amount, Jane's banking information, address, phone number, or other fields required to complete the transfer of funds.

If the memo validation system 320 determines that the one or more transfer memo themes of a selected recipient from the one or more candidate recipients do not exceed a predetermined similarity threshold when compared to the one or more themes, then a security action can be initiated. The memo validation system 320 may initiate a security action such as automatically denying the request, causing the GUI of John's cell phone (e.g., user device 420) to prompt the user to re-enter the intended recipient information, or initiating a transfer of only a portion of a total transfer amount. Otherwise, if the memo validation system 320 determines that the one or more transfer memo themes of a selected recipient from the one or more candidate recipients exceed the predetermined similarity threshold when compared to the one or more themes, then the transfer of funds can be completed using the transfer information provided in the transfer request.

In another example, a customer John needs to send funds to a recipient Janet for furniture by using his laptop, a user device 402. In this example, John also has never sent funds to Janet before. After John gains access to the account, as described above, John may enter intended recipient information relating to Janet or Janet's furniture company and the memo validation system 320 may then dynamically identify a list of one or more candidate recipients based on Janet's username. In this example, Janet may have one or more accounts. The memo validation system 320 may then generate a GUI comprising the list of the one or more candidates which may include the one or more accounts and transmit the GUI to the user device 402. The memo validation system 320 may retrieve a plurality of past transactions from the memo validation system database 360 based on associations between the plurality of past transactions and each of the candidate recipients. The memo validation system 320 can then obtain past memo information from the plurality of past transactions. The memo validation system 320 can then identify one or more themes associated with the plurality of past transactions associated with each of the candidate recipients by applying natural language processing to the past memo information. A theme associated with the plurality of past transactions of one of the candidate recipients can relate to furniture. The memo validation system 320 can dynamically receive transfer memo information from the user device 420. In this example, John may enter a date the furniture transaction was completed, an address of the work site, and a type of service that was provided (e.g., furniture sale). As John enters each character, word, or phrase as the transfer memo information, the memo validation system 320 can dynamically adjust the order of the list of the one or more candidate recipients based on a comparison of the one or more themes and the transfer memo information. The memo validation system 320 may rank the candidate or one of the accounts of Janet with the theme relating to furniture services higher on the list of the one or more candidates because the services John intends to pay for matches past transactions of the candidate recipient. The memo validation system 320 may also use the natural language processor to determine one or more transfer memo themes derived from the transfer memo information as it is dynamically received. John may then send, via the user device 420, a transfer request to initiate the transfer of funds to Janet's account. If the memo validation system 320 determines that the one or more transfer memo themes of a selected recipient from the one or more candidate recipients do not exceed a predetermined similarity threshold when compared to the one or more themes, then a security action can be initiated (as outlined above and not repeated here for brevity). Otherwise, the transfer of funds can be completed using the transfer information provided in the transfer request.

In another example, a customer John needs to send funds between two of John's accounts by using his laptop, a user device 402. In this example, John may have one or more accounts. In this example, John also has never sent funds between the two of John's accounts before. After John gains access to the account, as described above, John may enter intended recipient information relating to one of the two of John's accounts and the memo validation system 320 may then dynamically identify a list of one or more candidate recipients (one or more accounts belonging to John) based on the intended recipient information (such as John's username). The memo validation system 320 may then generate a GUI comprising the list of the one or more candidates which may include the one or more accounts and transmit the GUI to the user device 402. The memo validation system 320 may retrieve a plurality of past transactions from the memo validation system database 360 based on associations between the plurality of past transactions and each of the candidate recipients (each of John's one or more accounts). The memo validation system 320 can then obtain past memo information from the plurality of past transactions. The memo validation system 320 can then identify one or more themes associated with the plurality of past transactions associated with each of John's one or more accounts by applying natural language processing to the past memo information. A theme associated with the plurality of past transactions of each of John's one or more accounts can relate to bills. The memo validation system 320 can dynamically receive transfer memo information from the user device 420. In this example, John may enter a date a bill was paid. As John enters each character, word, or phrase as the transfer memo information, the memo validation system 320 can dynamically adjust the order of the list of the one or more candidate recipients (John's one or more accounts) based on a comparison of the one or more themes and the transfer memo information. The memo validation system 320 may rank one of John's one or more accounts based on identified themes relating to bills higher on the list of the one or more candidates. The memo validation system 320 may also use the natural language processor to determine one or more transfer memo themes derived from the transfer memo information as it is dynamically received. John may then send, via the user device 420, a transfer request to initiate the transfer of funds to John's identified account. If the memo validation system 320 determines that the one or more transfer memo themes of a selected recipient from the one or more candidate recipients do not exceed a predetermined similarity threshold when compared to the one or more themes, then a security action can be initiated (in one example, considering the transfer request was for one or more accounts belonging to John, the memo validation system 320 may cause the GUI of the user device 420 to prompt the user to re-enter the intended recipient information). Otherwise, the transfer of funds can be completed using the transfer information provided in the transfer request.

In some examples, disclosed systems or methods may involve one or more of the following clauses:

Clause 1: A system comprising: one or more processors; and a memory in communication with the one or more processors and storing instructions that, when executed by the one or more processors, are configured to cause the system to: receive recipient identification information from a user device; identify a list of one or more candidate recipients based on the recipient identification information; output the list of the one or more candidate recipients for display via a graphical user interface (GUI) of the user device; for each candidate recipient of the one or more candidate recipients, identify one or more themes associated with past transactions associated with the candidate recipient; and responsive to dynamically receiving transfer memo information from the user device, dynamically adjust an order of the list of the one or more candidate recipients for display via the GUI of the user device based on comparing the one or more themes and the transfer memo information.

Clause 2: The system of claim 1, wherein the recipient identification information comprises one of: a phone number, an address; an email address; or a name.

Clause 3: The system of claim 1, wherein identifying the list of the one or more candidate recipients comprises: identifying one or more user profiles having associated identification information within a predetermined threshold level of similarity to the recipient identification information.

Clause 4: The system of claim 1, wherein identifying one or more themes associated with past transactions associated with the candidate recipient comprises: identifying a plurality of past transactions in which the candidate recipient was a recipient; obtaining past memo information, wherein past memo information comprises information entered into a memo line associated with each transaction of the plurality of past transactions; and applying natural language processing to the past memo information to identify the one or more themes associated with past transactions.

Clause 5: The system of claim 1, wherein dynamically ordering the list of the one or more candidate recipients for display via the GUI of the user device based on the one or more themes and the transfer memo information comprises: determining a degree of similarity between one or more transfer memo themes derived from the transfer memo information and the one or more themes associated with past transactions for each candidate recipient of the one or more candidate recipients; weighting a ranking of each candidate recipient of the one or more candidate recipients based on the degree of similarity between the one or more transfer memo themes and the one or more themes associated with past transactions associated with the candidate recipient; and dynamically order the list of the one or more candidate recipients based on the ranking of each candidate recipient.

Clause 6: The system of claim 5, wherein each ranking of each candidate recipient of the one or more candidate recipients is further weighted based on a second degree of similarity between the recipient identification information and identification information associated with a user profile associated with the candidate recipient.

Clause 7: A system comprising: one or more processors; and a memory in communication with the one or more processors and storing instructions that, when executed by the one or more processors, are configured to cause the system to: receive intended recipient information and transfer memo information; identify, based on the intended recipient information, a recipient; identify, by applying natural language processing (NLP) to the transfer memo information, one or more transfer memo themes; receive a transfer request, wherein the transfer request indicates a request to initiate a transfer to the recipient; obtain historical memo information associated with one or more past transfers to the recipient; identify, by applying NLP to the historical memo information, one or more recipient themes; and responsive to determining that the one or more transfer memo themes do not exceed a predetermined similarity threshold when compared to the one or more recipient themes, initiate a security action.

Clause 8: The system of claim 7, wherein the intended recipient information and the transfer memo information are received via a graphical user interface (GUI) of a user device.

Clause 9: The system of claim 8, wherein the instructions are further configured to cause the system to: responsive to determining that the one or more transfer memo themes do not exceed the predetermined similarity threshold when compared to the one or more recipient themes: identify one or more candidate recipients based on the intended recipient information, wherein each of the one or more candidate recipients has an associated set of past memo information associated with past transfers made to the candidate recipient; for each of the one or more candidate recipients, identify, by applying NLP to the associated set of past memo information, one or more recipient memo themes associated with the past transfers made to the candidate recipient; for each of the one or more candidate recipients, determine an associated degree of similarity between the one or more recipient memo themes and the one or more transfer memo themes; and transmit data to the user device that is configured to cause the GUI of the user device to display a list of the one or more candidate recipients along with the respective associated degree of similarity.

Clause 10: The system of claim 8, wherein the security action comprises one or more of: automatically denying the request; causing the GUI of the user device to prompt the user to re-enter the intended recipient information; and initiating a transfer of only a portion of a total transfer amount.

Clause 11: The system of claim 7, wherein identifying one or more transfer memo themes by applying NLP to the transfer memo information comprises: converting one or more words included in the transfer memo information into one or more word embeddings that are represented as one or more vectors; and comparing the one or more vectors to other vectors associated with known meanings to determine one or more meanings of the transfer memo information.

Clause 12: The system of claim 11, identifying one or more transfer memo themes by applying NLP to the transfer memo information further comprises: applying a clustering algorithm to the other vectors associated with known meanings; and identifying one or more clusters that the one or more vectors correspond to when plotted.

Clause 13: The system of claim 7, wherein the instructions are further configured to cause the system to: receive a privacy filter input associated with the recipient, wherein the privacy filter input represents a private theme designated by the recipient; and remove the private theme from the one or more recipient themes prior to comparing the one or more recipient themes to the one or more transfer memo themes.

Clause 14: A system comprising: one or more processors; and a memory in communication with the one or more processors and storing instructions that, when executed by the one or more processors, are configured to cause the system to: receive intended recipient information and transfer memo information; identify, based on the intended recipient information, a recipient; identify, by applying natural language processing (NLP) to the transfer memo information, one or more transfer memo themes; receive a transfer request, wherein the transfer request indicates a request to initiate a transfer to the recipient; obtain historical memo information associated with one or more past transfers to the recipient; identify, by applying NLP to the historical memo information, one or more recipient themes; determine, based on a comparison of the one or more transfer memo themes to the one or more recipient themes, a degree of similarity; and responsive to determining that the degree of similarity does not exceed a first predetermined similarity threshold, automatically deny the transfer request.

Clause 15: The system of claim 14, wherein the intended recipient information and the transfer memo information are received via a graphical user interface (GUI) of a user device.

Clause 16: The system of claim 15, wherein the instructions are further configured to cause the system to: responsive to determining that the degree of similarity does not exceed a first predetermined similarity threshold: identify one or more candidate recipients based on the intended recipient information, wherein each of the one or more candidate recipients has an associated set of past memo information associated with past transfers made to the candidate recipient; for each of the one or more candidate recipients, identify, by applying NLP to the associated set of past memo information, one or more recipient memo themes associated with the past transfers made to the candidate recipient; for each of the one or more candidate recipients, determine an associated degree of similarity between the one or more recipient memo themes and the one or more transfer memo themes; and transmit data to the user device that is configured to cause the GUI of the user device to display a list of the one or more candidate recipients along with the respective associated degree of similarity.

Clause 17: The system of claim 14, wherein the instructions are further configured to cause the system to: responsive to determining that the degree of similarity exceeds the first predetermined similarity threshold and does not exceed a second predetermined similarity threshold, initiate a security action.

Clause 18: The system of claim 17, wherein the security action comprises one of: initiating a transfer of a first amount and waiting a predetermined amount of time before initiating a transfer of a second amount, wherein the first amount and second amount are portions of a total amount associated with the transfer request; and transmit an authorization request to a user device associated with the transfer request and withhold the initiation of the initiation of the transfer to the recipient until an affirmative response to the authorization request is received from the user device.

Clause 19: The system of claim 17, wherein the instructions are further configured to cause the system to: responsive to determining that the degree of similarity exceeds the first predetermined similarity threshold and the second predetermined similarity threshold, initiate the transfer to the recipient.

Clause 20: The system of claim 14, wherein the instructions are further configured to cause the system to: receive a privacy filter input associated with the recipient, wherein the privacy filter input represents a private theme designated by the recipient; and remove the private theme from the one or more recipient themes prior to comparing the one or more recipient themes to the one or more transfer memo themes.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors; and
a memory in communication with the one or more processors and storing instructions that, when executed by the one or more processors, are configured to cause the system to:
receive recipient identification information from a user device;
identify a list of one or more candidate recipients based on the recipient identification information;
output the list of the one or more candidate recipients for display via a graphical user interface (GUI) of the user device;
for each candidate recipient of the one or more candidate recipients, identify one or more themes associated with past transactions associated with the candidate recipient; and
responsive to dynamically receiving transfer memo information from the user device, dynamically adjust an order of the list of the one or more candidate recipients for display via the GUI of the user device based on comparing the one or more themes and the transfer memo information.

2. The system of claim 1, wherein the recipient identification information comprises one of:
a phone number;
an address;
an email address; or
a name.

3. The system of claim 1, wherein identifying the list of the one or more candidate recipients comprises:
identifying one or more user profiles having associated identification information within a predetermined threshold level of similarity to the recipient identification information.

4. The system of claim 1, wherein identifying one or more themes associated with past transactions associated with the candidate recipient comprises:
identifying a plurality of past transactions in which the candidate recipient was a recipient;
obtaining past memo information, wherein past memo information comprises information entered into a memo line associated with each transaction of the plurality of past transactions; and
applying natural language processing to the past memo information to identify the one or more themes associated with past transactions.

5. The system of claim 1, wherein dynamically ordering the list of the one or more candidate recipients for display via the GUI of the user device based on the one or more themes and the transfer memo information comprises:
determining a degree of similarity between one or more transfer memo themes derived from the transfer memo information and the one or more themes associated with past transactions for each candidate recipient of the one or more candidate recipients;
weighting a ranking of each candidate recipient of the one or more candidate recipients based on the degree of similarity between the one or more transfer memo themes and the one or more themes associated with past transactions associated with the candidate recipient; and
dynamically order the list of the one or more candidate recipients based on the ranking of each candidate recipient.

6. The system of claim 5, wherein each ranking of each candidate recipient of the one or more candidate recipients is further weighted based on a second degree of similarity between the recipient identification information and identification information associated with a user profile associated with the candidate recipient.

7. A system comprising:
one or more processors; and
a memory in communication with the one or more processors and storing instructions that, when executed by the one or more processors, are configured to cause the system to:
receive intended recipient information and transfer memo information;
identify, based on the intended recipient information, a recipient;
identify, by applying natural language processing (NLP) to the transfer memo information, one or more transfer memo themes;
receive a transfer request, wherein the transfer request indicates a request to initiate a transfer to the recipient;
obtain historical memo information associated with one or more past transfers to the recipient;
identify, by applying NLP to the historical memo information, one or more recipient themes; and
responsive to determining that the one or more transfer memo themes do not exceed a predetermined similarity threshold when compared to the one or more recipient themes, initiate a security action.

8. The system of claim 7, wherein the intended recipient information and the transfer memo information are received via a graphical user interface (GUI) of a user device.

9. The system of claim 8, wherein the instructions are further configured to cause the system to:
responsive to determining that the one or more transfer memo themes do not exceed the predetermined similarity threshold when compared to the one or more recipient themes:
identify one or more candidate recipients based on the intended recipient information, wherein each of the one or more candidate recipients has an associated set of past memo information associated with past transfers made to the candidate recipient;
for each of the one or more candidate recipients, identify, by applying NLP to the associated set of past memo information, one or more recipient memo themes associated with the past transfers made to the candidate recipient;
for each of the one or more candidate recipients, determine an associated degree of similarity between the one or more recipient memo themes and the one or more transfer memo themes; and
transmit data to the user device that is configured to cause the GUI of the user device to display a list of the one or more candidate recipients along with the respective associated degree of similarity.

10. The system of claim 8, wherein the security action comprises one or more of:
automatically denying the request;
causing the GUI of the user device to prompt the user to re-enter the intended recipient information; and
initiating a transfer of only a portion of a total transfer amount.

11. The system of claim 7, wherein identifying one or more transfer memo themes by applying NLP to the transfer memo information comprises:
converting one or more words included in the transfer memo information into one or more word embeddings that are represented as one or more vectors; and
comparing the one or more vectors to other vectors associated with known meanings to determine one or more meanings of the transfer memo information.

12. The system of claim 11, identifying one or more transfer memo themes by applying NLP to the transfer memo information further comprises:
applying a clustering algorithm to the other vectors associated with known meanings; and
identifying one or more clusters that the one or more vectors correspond to when plotted.

13. The system of claim 7, wherein the instructions are further configured to cause the system to:
receive a privacy filter input associated with the recipient, wherein the privacy filter input represents a private theme designated by the recipient; and
remove the private theme from the one or more recipient themes prior to comparing the one or more recipient themes to the one or more transfer memo themes.

14. A system comprising:
one or more processors; and
a memory in communication with the one or more processors and storing instructions that, when executed by the one or more processors, are configured to cause the system to:
receive intended recipient information and transfer memo information;
identify, based on the intended recipient information, a recipient;
identify, by applying natural language processing (NLP) to the transfer memo information, one or more transfer memo themes;
receive a transfer request, wherein the transfer request indicates a request to initiate a transfer to the recipient;
obtain historical memo information associated with one or more past transfers to the recipient;
identify, by applying NLP to the historical memo information, one or more recipient themes;
determine, based on a comparison of the one or more transfer memo themes to the one or more recipient themes, a degree of similarity; and
responsive to determining that the degree of similarity does not exceed a first predetermined similarity threshold, automatically deny the transfer request.

15. The system of claim 14, wherein the intended recipient information and the transfer memo information are received via a graphical user interface (GUI) of a user device.

16. The system of claim 15, wherein the instructions are further configured to cause the system to:
responsive to determining that the degree of similarity does not exceed a first predetermined similarity threshold:
identify one or more candidate recipients based on the intended recipient information, wherein each of the one or more candidate recipients has an associated set of past memo information associated with past transfers made to the candidate recipient;
for each of the one or more candidate recipients, identify, by applying NLP to the associated set of past memo information, one or more recipient memo themes associated with the past transfers made to the candidate recipient;
for each of the one or more candidate recipients, determine an associated degree of similarity between the one or more recipient memo themes and the one or more transfer memo themes; and
transmit data to the user device that is configured to cause the GUI of the user device to display a list of the one or more candidate recipients along with the respective associated degree of similarity.

17. The system of claim 14, wherein the instructions are further configured to cause the system to:
responsive to determining that the degree of similarity exceeds the first predetermined similarity threshold and does not exceed a second predetermined similarity threshold, initiate a security action.

18. The system of claim 17, wherein the security action comprises one of:
initiating a transfer of a first amount and waiting a predetermined amount of time before initiating a transfer of a second amount, wherein the first amount and second amount are portions of a total amount associated with the transfer request; and
transmit an authorization request to a user device associated with the transfer request and withhold the initiation of the initiation of the transfer to the recipient until an affirmative response to the authorization request is received from the user device.

19. The system of claim 17, wherein the instructions are further configured to cause the system to:
responsive to determining that the degree of similarity exceeds the first predetermined similarity threshold and the second predetermined similarity threshold, initiate the transfer to the recipient.

20. The system of claim 14, wherein the instructions are further configured to cause the system to:
receive a privacy filter input associated with the recipient, wherein the privacy filter input represents a private theme designated by the recipient; and
remove the private theme from the one or more recipient themes prior to comparing the one or more recipient themes to the one or more transfer memo themes.
